(19) United States
(12) Patent Application Publication
(10) Pub. No.: US 2025/0268226 A1
(43) Pub. Date: Aug. 28, 2025

(54) Manually Activated Motorized Pumping of Waste Disposal Cat Litter Box

(71) Applicant: Lily Berry, Tobyhanna, PA (US)

(72) Inventor: Lily Berry, Tobyhanna, PA (US)

(21) Appl. No.: 18/586,123

(22) Filed: Feb. 23, 2024

(51) Int. Cl. A01K 1/01

(52) U.S. Cl. CPC A01K 1/0114; A01K 1/0107; A01K 1/011

(57) ABSTRACT

The present invention discloses a manually activated motorized pumping device integrated into a cat litter box system, providing efficient waste disposal. The system consists of two units: an upper unit with draining holes for urine and a larger bottom unit serving as a wastewater containment chamber. The upper unit is filled with non-absorbable granules, such as small fish aquarium gravel, while the transparent bottom unit allows for monitoring of wastewater levels. Urine drains from the upper unit into the wastewater containment unit, while fecal matter can be removed, and granules cleaned with a watering bucket or can. Granules soaked in urine are also washable for continuous cleanliness. The bottom unit holds multiple gallons of wastewater, draining at the owner's discretion or when it reaches a predetermined level. Tubing connected to the wastewater drainage system can be attached to a toilet seat, drain sink, or wastewater bucket for disposal.

### STATEMENT REGARDING FEDERALLY SPONSORED RESEARCH OR DEVELOPMENT

Not Applicable

### TECHNICAL FIELD

The present disclosure relates to a cat litter box system. More specifically, the invention relates to a manually activated motorized pumping device integrated into a cat litter box system with versatile disposal options.

### BACKGROUND OF THE INVENTION

Traditional cat litter boxes often require manual scooping of waste and periodic complete replacement of litter. This process can be messy, time-consuming, and unpleasant. The present invention aims to provide an improved cat litter box system that facilitates easy waste disposal without the need for complicated plumbing connections.

### DESCRIPTION OF THE RELATED ART

The combination of the upper and bottom units, along with the manual pumping system, and waste disposal options, addresses the shortcomings of existing solutions and provides a more convenient alternative for maintaining a clean litter box environment.

U.S. patent application U.S. Pat. No. 10,701,892B2 by W. M Dale Brown, published July 7, 2019 Is a urine pet flushing litter box. The Litter box includes a removable top open upper litter tray with a perforated bottom, and a lower liquid holding tank, which is placed under the upper liter tray to collect urine discharged by the upper liter tray. The lower liquid tray has plumbing and an electrical component. The upper liter tray holds non-absorbent litter material. There is a connected inlet end that receives household pressurized water. There is another inlet hole, connected to a venturi pump, that vacuums contaminated urine water from inside the liquid holding tank and out the drain. This invention has limitations in that it has to be connected to the household plumbing system.

U.S. patent application 2023040424A1 by Melinda Magee, published Dec,21, 2023. A litter housing assembly that is posited against an exterior wall of the building having the entry aligned with a window in the exterior wall. A drip pan is positioned in the housing and cat litter is positioned on the drip pan to facilitate the cat to urinate and defecate in the cat litter. The invention has a lot of limitations. The use of a drip pan inside the housing may lead to issues with spillage and mess. If the cat kicks or scatters litter outside the drip pan, it could result in additional cleanup efforts for the owner. The litter box's proximity to an exterior wall makes it more susceptible to weather-related challenges, such as rain or snow entering through the window. Placing the litter housing assembly against an exterior wall may limit proper ventilation, leading to potential odor buildup within the housing.

### SUMMARY

The invention is a manually activated motorized pumping device integrated into a cat litter box system for efficient disposal of waste. The system comprises two units: an upper unit with draining holes for urine and a bottom unit that is at least twice as large as the top unit, functioning as a wastewater containment chamber. The upper unit is filled with non-absorbable granules, such as small fish aquarium gravel, while the bottom unit is transparent for measurable levels and monitoring of waste water levels. On the top unit, the urine drains through openings down into the waste water containment unit. Also, fecal matter can be picked up and the granules can be washed clean of fecal smears with a traditional watering bucket or can. Also, granules soaked in urine can also be washed clean with the watering can or bucket to ensure clean granules at all times. The bottom unit is designed to hold multiple gallons of waste water in order to drain at the owner's convenience or discretion once it reaches a self determined level. The connected tubing draining waste water can attached or clipped to the toilet seat, drain sink or waster water bucket for disposal. The described invention offers a novel and practical solution for cat owners seeking an efficient, easy-to-use, cleaner and cost-effective self-cleaning cat litter box.

### ADVANTAGES

Efficient Waste Disposal. Waste water is manually pumped out when the level reaches capacity, or at the owner's discretion eliminating the need for manual scooping and digging of a traditional litter box.

Easy Monitoring. Transparent bottom unit with measurable indicators allows users to visually monitor waste accumulation and drain at their convenience.

Versatile Disposal Options. Waste can be directed to a toilet, drainage sink, or waste bucket, providing flexibility in disposal methods.

No Complex Installation. Does not require complicated connections to water pipes or sewer lines, making it suitable for various living environments.

Cleaning litter granules of fecal smears and urine soaked granules with water from a watering bucket or device ensures clean litter paws, and the bottom unit is designed larger to hold additional waste water for this cleaning process.

### BRIEF DESCRIPTION OF DRAWINGS

FIG. 1 Depicts an example of a perspective assembled view of the invention.

FIG. 2 Depicts an example of a perspective disassembled view of the invention.

FIG. 3 Depicts an example of a perspective side view of the invention.

### DETAILED DESCRIPTION OF DRAWINGS

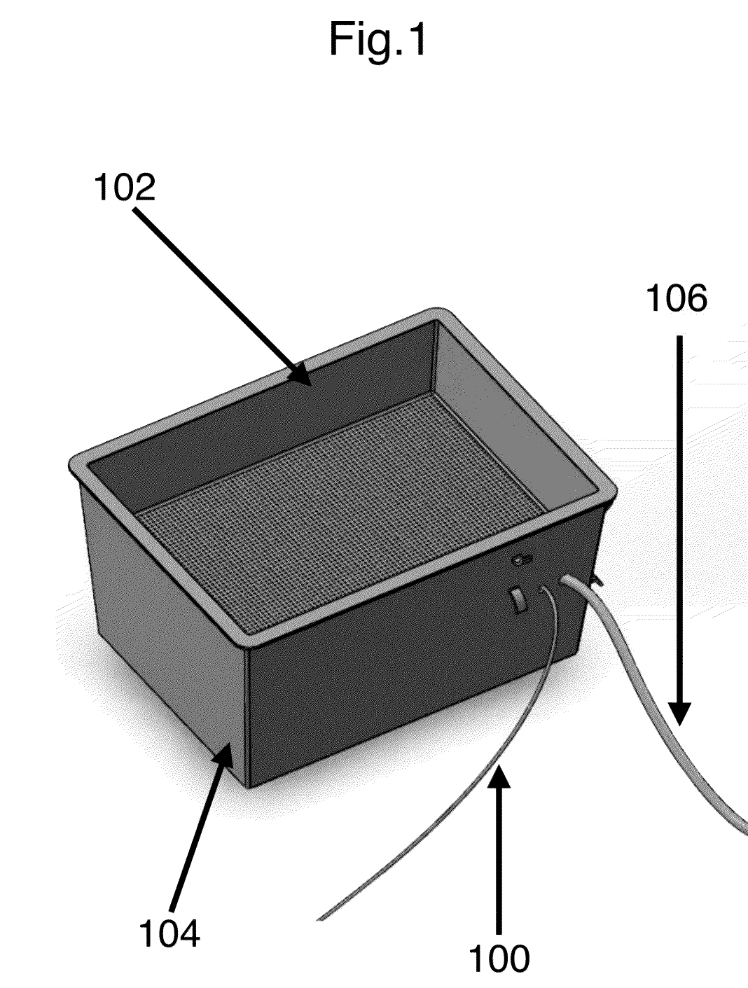

FIG. 1 Depicts an example of a perspective assembled view of the invention. 102 is the top part of the cat litter box. Contains draining holes for urine.

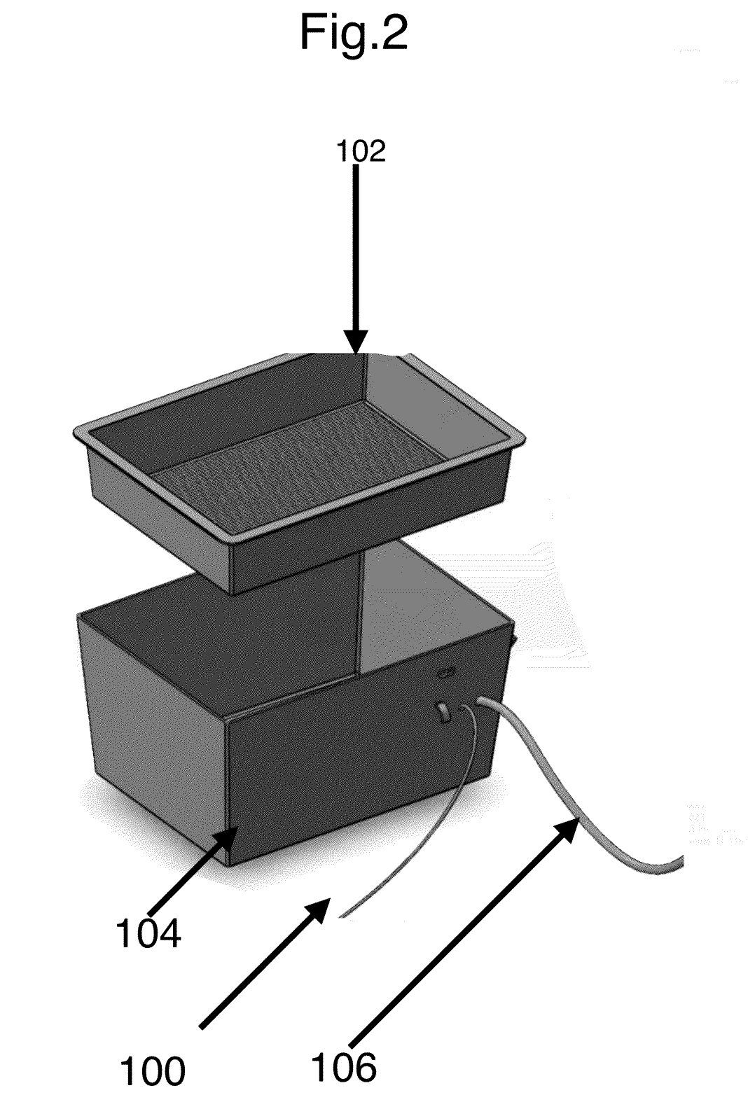

FIG. 2 Depicts an example of a perspective exploded view of the invention, 104 is the bottom unit which functions as a containment chamber.

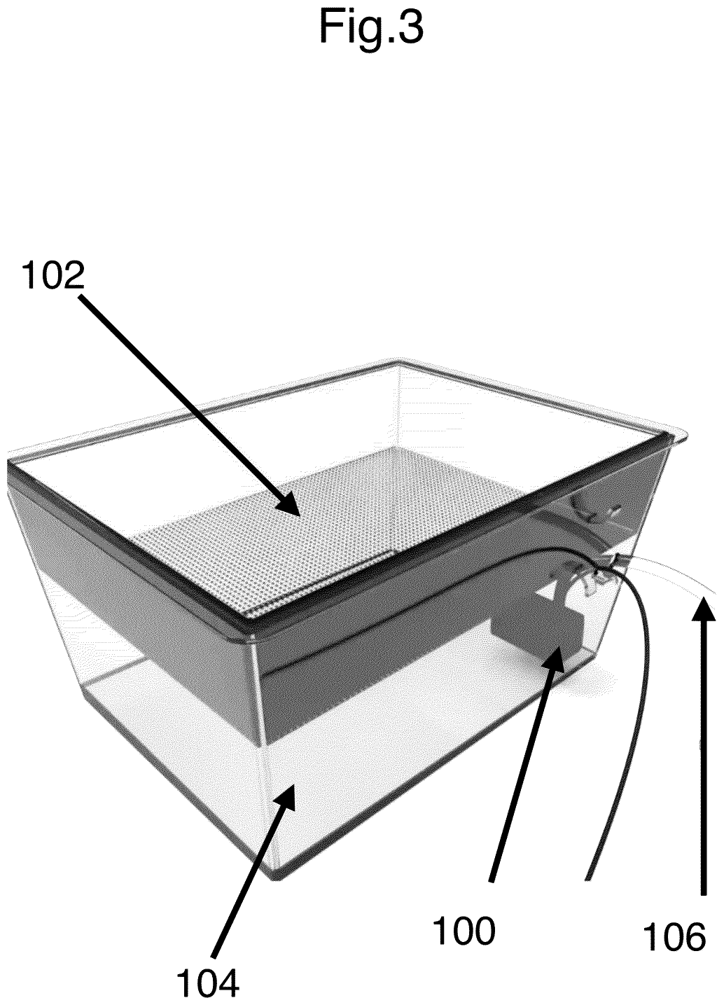

FIG. 3 Depicts an example of a perspective side view of the invention. 100 is the pumping device. It is Integrated into the bottom unit. 106 is the tubing and Clip for attachment to a toilet seat, drainage sink, or wastewater bucket.

What is claimed is:

1. A motorized pumping device integrated into a cat litter box system, comprising:
An upper unit with draining holes for urine draining.
A large clear bottom unit with measuring lines functioning as a waste containment chamber.
A manually turned-on pumping device inside the bottom unit can be activated when waste water reaches a predetermined level.
Tubing connected to the pumping device, equipped with a clip for attachment to a toilet seat, drainage sink, or wastewater bucket.
